(19) United States
(12) Patent Application Publication
(10) Pub. No.: US 2024/0392899 A1
(43) Pub. Date: Nov. 28, 2024

(54) INDUCTION FUSED THERMOPLASTIC PIPE

(71) Applicant: Fiber Glass Systems, L.P., Dover, TX (US)

(72) Inventors: James Pisarkiewicz, San Antonio, TX (US); David Wayne Granderson, San Antonio, TX (US)

(21) Appl. No.: 18/667,534

(22) Filed: May 17, 2024

Related U.S. Application Data
(60) Provisional application No. 63/503,607, filed on May 22, 2023.

(51) Int. Cl. F16L 11/08; B29C 65/36; B29C 70/34; B29L 23/00; F16L 11/127

(52) U.S. Cl. CPC F16L 11/082; B29C 65/3644; B29C 70/34; F16L 11/127; B29L 2023/005

(57) ABSTRACT

A pipe may include an inner thermoplastic pipe and an outer layer of thermoplastic material. The outer layer of thermoplastic material may be wrapped around the inner thermoplastic pipe. The outer layer of thermoplastic material may be fused with the inner thermoplastic pipe. The pipe may also include an induction heating compatible material (IHCM) within or between at least one of the inner thermoplastic pipe or the outer layer of thermoplastic material.

### CROSS-REFERENCE TO RELATED

This patent application claims the benefit of U.S. Provisional Patent Application No. 63/503,607, filed May 22, 2023, which is incorporated by reference herein in its entirety.

### TECHNOLOGICAL FIELD

The present disclosure relates to pipe. More particularly, the present disclosure relates to thermoplastic pipe. Still more particularly, the present disclosure relates to thermoplastic pipe that is manufactured using induction heating.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Pipes can be used to transport one or more of liquids, gasses, and slurries. A pipe may include a wall for containing the transportable material, and a bore for carrying the transportable material. In some cases, for example thermoplastic pipe, the pipe wall may include one or more materials or layers that are connected by one or more of glue, fusing, or mechanical bonding.

In the case of fusing, one or more layers may be fused by heating the respective layer(s) until fusing occurs. The heating may involve heating the entire thickness of the respective layers until they soften or flow. In some cases, the entire thickness of pipe, including the respective layers to be fused, may be heated by an external heater until the junction of the respective layers reaches the desired temperature. These current processes are energy intensive, time consuming, and imprecise.

### SUMMARY

In an example, a pipe may include an inner thermoplastic pipe and an outer layer of thermoplastic material. The outer layer of thermoplastic material may be wrapped around the inner thermoplastic pipe. The outer layer of thermoplastic material may be fused with the inner thermoplastic pipe. The pipe may also include an induction heating compatible material (IHCM) within or between at least one of the inner thermoplastic pipe or the outer layer of thermoplastic material.

In an example, a method of manufacturing a pipe may include wrapping an inner thermoplastic pipe with an outer layer of thermoplastic material, where at least one of the inner thermoplastic pipe, the outer layer of thermoplastic material, or a separate layer may provide an induction heating compatible material (IHCM). The method may also include using an induction heater to heat the IHCM to fuse the inner thermoplastic pipe with the outer layer of thermoplastic material.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

In the drawings, which may not be drawn to scale, like numerals may describe substantially similar components throughout one or more of the views. Like numerals having different letter suffixes may represent different instances of substantially similar components. The drawings illustrate generally, by way of example but not by way of limitation.

FIG. 1 shows an example of installing thermoplastic pipe, according to one or more examples.

FIG. 2 is a perspective view of thermoplastic pipe depicting one or more layers including an induction heating compatible material, according to one or more examples.

FIG. 3 is a cross-sectional view of the thermoplastic pipe of FIG. 2.

FIG. 4 is a diagram depicting an example of a method for manufacturing the thermoplastic pipe of FIGS. 1-3.

FIG. 5 is a perspective view of an example of portions of a thermoplastic pipe being manufactured and portions of a system for manufacturing the thermoplastic pipe.

### DETAILED DESCRIPTION

The present disclosure, in one or more examples, relates to a plastic pipe that is manufactured using induction heating. The pipe may include an induction heating compatible material (IHCM) and induction heating can be used to heat the IHCM. An IHCM may be an electrically conductive material and induction heating may heat the IHCM by inducing an electric current in the IHCM using an electric, a magnetic, or an electromagnetic field, for example. The current induced in the IHCM may result in heat due to the resistance of the IHCM. In this way, heating of the IHCM may be accomplished without direct physical contact between the energy source generating the field and the IHCM. Additionally, the IHCM may allow for focused heating. For example, if the IHCM is within a material, the IHCM may be used to heat the material from the inside out and to control specific location of the heating.

Spoolable plastic pipe may be desirable because it is lightweight, flexible, easy to install, and/or cost-saving. A length of spoolable pipe may be able to be stored and transported in one piece on a spool or reel, for example. The length of spoolable pipe may be able to be installed in one continuous piece without joints, such as by unwinding from a spool. This may save time, save installation cost, allow installation where otherwise impractical, and/or result in a stronger installation.

A plastic pipe may be configured to include one or more layers of material in the wall. For example, a plastic pipe may include two layers of thermoplastic material in the wall. The layers of thermoplastic may be combined by glueing and/or fusing, for example. The layers of thermoplastic in the wall may be placed and then heated using one or more of radiant, convective, or conductive heating to fuse the layers.

The present inventors have recognized, among other things, that the layers of thermoplastic material may be fused using induction heating. That is, the induction heating may be used to generate heat in an IHCM arranged within the pipe wall. This may result in a production process that is more efficient, more cost-effective, and/or quicker. A pipe constructed using induction heating may be more consistent and/or stronger than a pipe constructed without using induction heating. That is, a pipe manufactured at least in part using induction heating may cool quicker or may not require as much cooling effort to cool to a specified temperature because a smaller portion of the cross-section may be heated in the first place. Using induction heating may allow some portions of the pipe to remain cooler, which may allow for the cooler portions to retain a higher level of structural integrity during manufacturing. That is, excessive heat input in a pipe manufacturing process may cause thermal expansion of the pipe, which may result in stress within the finished pipe. The presently disclosed process may help to reduce the overall heat input in the pipe manufacturing process.

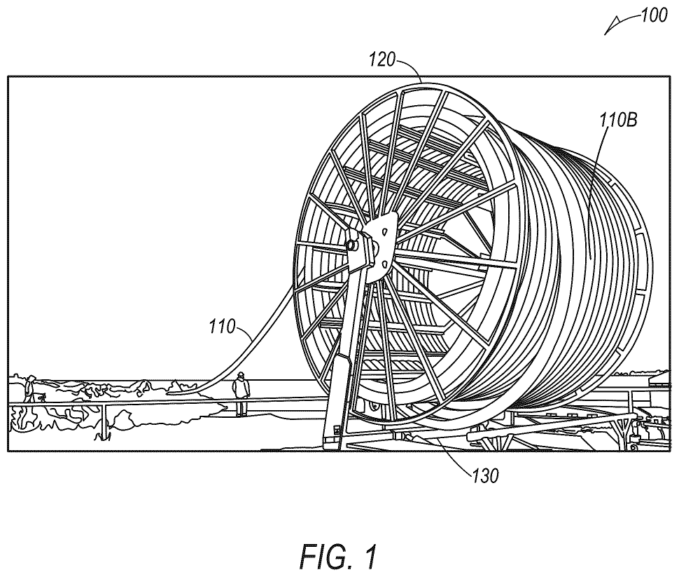

FIG. 1 shows an example 100 of a pipe installation. FIG. 1 shows pipe 110 being installed off of a spool 120. The spool 120 contains a length of pipe 110B. The length of pipe 110B may be continuous on the spool 120, which may allow the entire length of pipe 110B to be installed without connections or joints. The spool 120 may be stored on a portable trailer 130 which may allow the pipe to be transported from a location of storage or manufacturing to the location of installation and may provide for moving the spool 120 along the installation site while the pipe 110 is being unwound off of the spool 120.

The pipe 110 may be flexible to allow the pipe 110 to be spooled on and off the spool 120. The diameter of the spool 120 may be selected to allow the pipe 110 to be spooled without damaging the pipe 110. The pipe 110 may have a selected strength and durability that allows the pipe 110 to be used in harsh environments. The pipe 110 may be used to carry a variety of liquids, gasses, and slurries. In an example, the pipe may carry water, including a mixture of water and other chemicals.

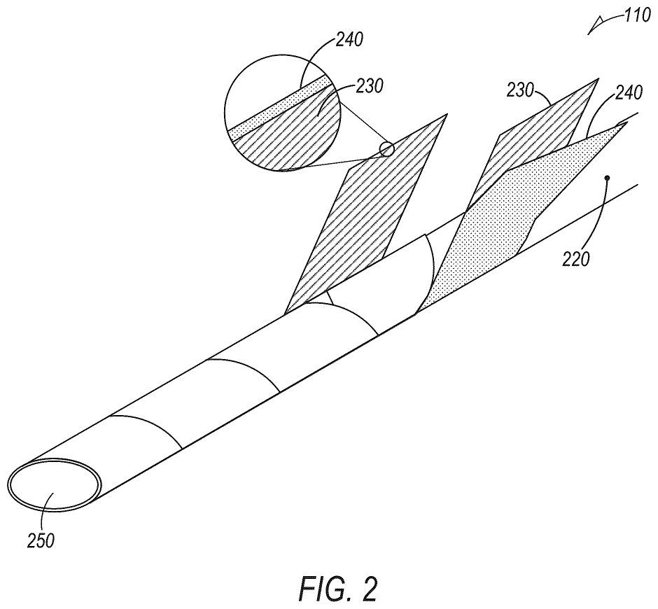

FIG. 2 is a perspective view of an example of a portion of a pipe 110. FIG. 2 shows that the pipe 110 may include an inner thermoplastic pipe 220, one or more outer layers of thermoplastic material 240, and an induction heating compatible material (IHCM) 230.

The inner thermoplastic pipe 220 may be an unreinforced thermoplastic shell. The inner thermoplastic pipe 220 may be an extruded pipe, and may have a selected inner diameter, outer diameter, and wall thickness. The inner thermoplastic pipe 220 may be circular or substantially circular, and the thickness of the walls may be consistent or substantially consistent. The inner diameter of the inner thermoplastic pipe 220 may define a bore 250. In an example, the inner thermoplastic pipe 220 may include one or more of polyvinyl chloride (PVC), polypropylene (PP), polyethylene (PE), nylon, acrylonitrile butadiene styrene (ABS), or other thermoplastic.

The one or more outer layers of thermoplastic material 240 may surround the inner thermoplastic pipe 220, and may be fused to the inner thermoplastic pipe 220. The outer layer of thermoplastic material 240 may include one or more of a strand, tape, or sheet. The outer layer of thermoplastic material 240 may be reinforced, such as may include a high relative tensile modulus reinforced thermoplastic material (HRTMRTM). There may be multiple overlapping outer layers of thermoplastic material 240, such as may include 1 layer, 2 layers, 3 layers, 4 layers, or 5 layers as illustrative examples. In an example, the one or more outer layers of thermoplastic material 240 may include one or more of polyvinyl chloride (PVC), polypropylene (PP), polyethylene (PE), nylon, acrylonitrile butadiene styrene (ABS), or other thermoplastic. In an example, the one or more outer layers of thermoplastic material 240 may be reinforced using at least one of fiberglass or carbon fiber.

The inner thermoplastic pipe 220 and the one or more outer layers of thermoplastic material 240 may be fused, such as through the heating of one or more of the inner thermoplastic pipe 220 or the one or more outer layers of thermoplastic material 240 until one or more adjacent layers fuse. In an example, the inner thermoplastic pipe 220 and the outer layer of thermoplastic material 240 may be melted together to form one nearly continuous piece of thermoplastic material. In an example, the bonds between the inner thermoplastic pipe 220 and the outer layer of thermoplastic material 240 may be similar or substantially identical to the bonds within one or more of the inner thermoplastic pipe 220 or the outer layer of thermoplastic material 240. For example, one or more polymer chains within the inner thermoplastic pipe 220 may be bonded through intermolecular forces, such as Van der Walls forces. Heating one or more of the inner thermoplastic pipe 220 or the outer layer of thermoplastic material 240 may allow for the formation of intermolecular forces between the layers. This may be due to softening one or more of the layers to allow for closer physical contact or allowing for the rearrangement of polymer chains.

The IHCM 230 may be disposed within one or more of the inner thermoplastic pipe 220 or the outer layer of thermoplastic material 240, or between one or more layers. At least a portion of the IHCM 230 may be electrically conductive, which may allow for the formation of currents within the IHCM 230. The IHCM 230 may include a metal, such as iron or copper. The IHCM 230 may include a metalloid or nonmetal, such as carbon. In an example, the IHCM 230 may be carbon fiber and may include one or more of a carbon fiber filament, strand, mesh, mat, or fabric. In an example, the IHCM 230 may include distributed particles in one or more of the inner thermoplastic pipe 220 or the outer layer of thermoplastic material 240.

The IHCM 230 may be configured to provide heat through induction heating. The IHCM 230 may be configured to provide heat for fusing the inner thermoplastic pipe 220 and the outer layer of thermoplastic material 240. The IHCM 230 may be included within one or more regions of the inner thermoplastic pipe 220. Alternatively or additionally, the IHCM 230 may be included within one or more regions of the one or more outer layers of thermoplastic material 240. The IHCM 230 may be applied to an outer layer or face of the inner thermoplastic pipe 220 or an inner layer or face of the one or more outer layers of thermoplastic material 240.

In an example, the IHCM 230 may include a distinct layer between the inner thermoplastic pipe 220 and the outer layer of thermoplastic material 240. For example, the IHCM 230 may be one or more of a permeable mesh or fabric applied to the inner thermoplastic pipe 220 or between layers of the outer layer of thermoplastic material 240. The IHCM 230 might not be solid but may have pores or gaps, such as may allow a material to flow or seep through the IHCM 230.

At least a portion of the pipe 110 may be conductive to electricity along a length of the pipe 110, which may be due to the presence of the IHCM 230. For example, there may be a relatively low resistance path for electrons to travel along a length of pipe 110. This may allow the pipe 110 to be electrically grounded, which may lower the risk of a static discharge igniting a fire.

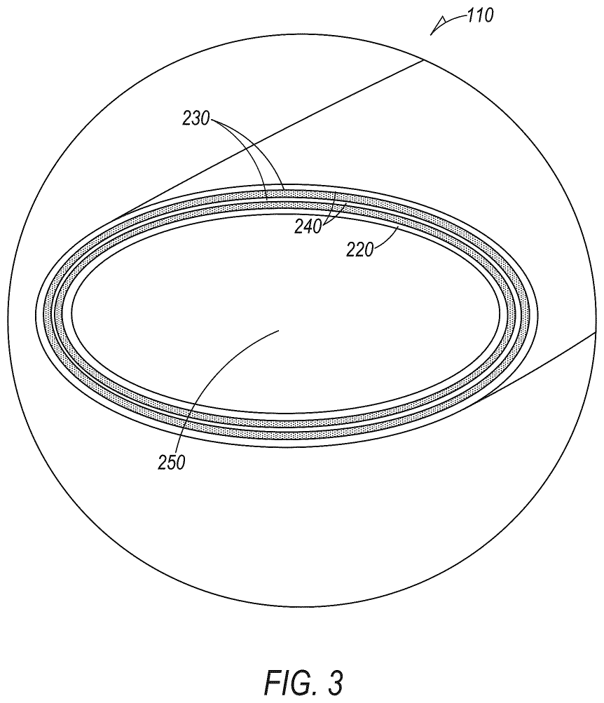

FIG. 3 is a cross-sectional view of an example of a portion of the pipe 110 of FIG. 2. FIG. 3 shows the inner thermoplastic pipe 220, the one or more layers of thermoplastic material 240, and the IHCM 230. FIG. 3 shows that an inner surface of the inner thermoplastic pipe 220 defines the bore 250 of the pipe 110. FIG. 3 also shows two outer layers of thermoplastic material 240, including 2 regions containing an IHCM 230. In an example, the IHCM 230 may be applied to a face of the thermoplastic material 240, or the outer layer of thermoplastic material 240 may be manufactured with an IHCM 230. In an example, the IHCM 230 may be a distinct layer included between the inner thermoplastic pipe 220 and the outer layer of thermoplastic material 240, as well as a distinct layer between respective outer layers of thermoplastic material 240.

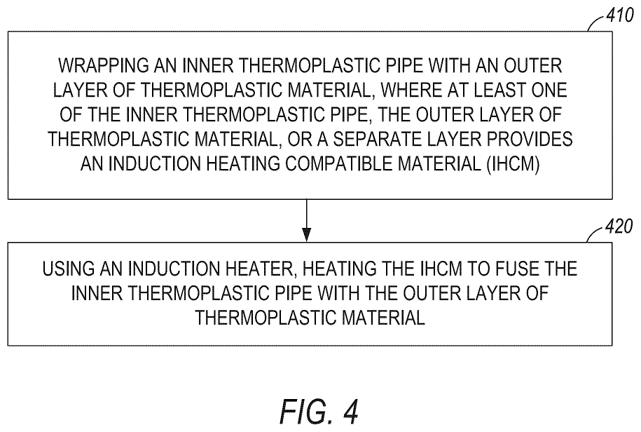

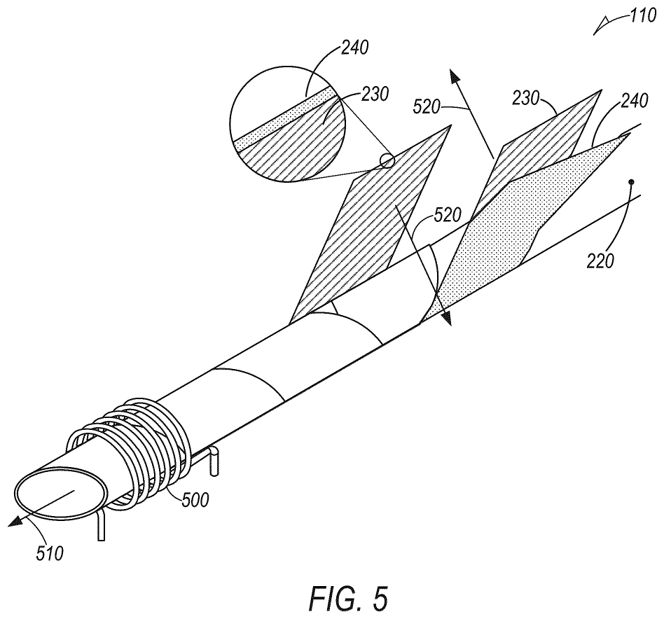

FIGS. 4-5 illustrate a process for forming a thermoplastic pipe. In particular, FIG. 4 is a flow chart showing an example of a method for manufacturing portions of a pipe. FIG. 5 is a perspective view of an example of portions of a pipe 110 being manufactured and portions of the system for manufacturing the pipe. As shown in FIG. 5, an inner thermoplastic pipe 220 may be wrapped 410 with an outer layer of thermoplastic material 240, where at least one of the inner thermoplastic pipe 220, the outer layer of thermoplastic material 240, or a separate layer provides an induction heating compatible material (IHCM) 230. Where the IHCM is a separate material, the process may include wrapping the inner thermoplastic pipe 220 with the IHCM material or wrapping an already-applied outer layer with the IHCM material. In the example of FIG. 5, the IHCM 230 is shown as a distinct layer applied with the outer layer of thermoplastic material 240. However, the IHCM 230 may be applied separately from the outer layer of thermoplastic material 240. In an example, the IHCM 230 may not be required to be applied as a separate layer because the IHCM 230 may already be contained within at least one of the inner thermoplastic pipe 220 or the outer layer of thermoplastic material 240 (e.g., previously embedded or otherwise incorporated into the inner thermoplastic pipe 220 or the outer layer of thermoplastic material 240).

The outer layer of thermoplastic material 240 may be wrapped onto the inner thermoplastic pipe 220 in at least one of a tape, strand, or sheet. The outer layer of thermoplastic material 240 may be wrapped in the direction of arrows 520. For example, two separate outer layers of thermoplastic material 240 may be wrapped onto the inner thermoplastic pipe 220 in opposing directions such that the layers overlap. In an example, a portion of the separate layers may overlap with themselves. In an example, the separate layers may equally cover each portion of the inner thermoplastic pipe 220. In an example, the separate layers may not cover each portion of the inner thermoplastic pipe 220, and there may be gaps between respective wraps of a given layer.

There may be an IHCM 230 near each seam between one or more of the inner thermoplastic pipe 220 or the outer layers of thermoplastic material 240. In an example, a single IHCM 230 layer may be used to fuse more than one seam, such as by heating up a specified portion of the pipe 110. In an example, each of the separate layers may be applied with an IHCM 230. In an example, less than all of the separate layers may be applied with an IHCM 230. Including an IHCM 230 either as a separate layer, on the face of, or within each separate layer of the outer layer of thermoplastic material 240 may help to ensure that there is an IHCM near every seam or junction of separate thermoplastic layers. This may help reduce the amount of heat that may be needed to form the pipe by helping to ensure that every thermoplastic junction has a nearby IHCM 230.

The pipe 110 may be heated 420 using an induction heater to fuse the inner thermoplastic pipe 220 with the outer layer of thermoplastic material 240. For example, the pipe may be passed through an induction heater including an induction heating coil 500 and an induction heating driver.

The induction heating coil 500 may be wrapped around a portion of the pipe 110. The induction heating coil 500 may not be required to touch the pipe 110 or the IHCM 230 to heat the IHCM 230. The induction heating coil 500 may be a conductive coil, such as may include a conductive coil of copper or other metal. The induction heating coil 500 may be driven by an induction heating driver, which as may produce an alternating current of a specified amplitude and frequency. In an example, the frequency of the alternating current may be relatively high, such as may include between 1000 Hz and 100,000 Hz, between 5,000 Hz and 50,000 Hz, or 10,000 Hz, as illustrative examples. The induction heating coil 500 may induce a current in at least a portion of the IHCM 230 which may cause the IHCM 230 to heat up due to resistive losses. The heat from the IHCM 230 may be passed by conduction to the surrounding thermoplastic material, which may result in one or more pieces of thermoplastic material fusing together.

The pipe may travel in the direction 510 at a specified speed such as may allow the induction heating coil 500 to heat the IHCM 230 and fuse respective layers of the pipe 110. The speed of travel in direction 510 may be configurable, which may allow an operator or computer to adjust the manufacturing process. Additionally or alternatively, the power output and/or other parameters of the induction heating coil 500 may be configurable, which may further allow an operator or computer to adjust the manufacturing process. In an example, one or more of the speed of travel or the parameters of the induction heating coil 500 may be adjusted based upon a monitored condition of the pipe 110, which, for example, may include the temperature of the pipe exiting the induction heating coil 500.

FIG. 4 illustrates an example of a method for manufacturing pipe 110. The shown order of steps is not intended to be a limitation on the order the steps are performed in. In an example, two or more steps may be performed simultaneously or at least partially concurrently. In an example, one or more steps may be omitted. In an example, one or more steps may be added.

Step 410 and step 420 may be performed simultaneously or at least partially concurrently. For example, the outer layer of thermoplastic material 240 may be wrapped onto a portion of the inner thermoplastic pipe 220 at the same time as at least one of (1) the portion being wrapped or (2) another portion of the pipe 110 is being heated by the induction heating coil 500. In the example of FIG. 5, one portion of the inner thermoplastic pipe 220 is wrapped with the outer layer of thermoplastic material 240 while a previously wrapped portion of the inner thermoplastic pipe 220 is heated using the induction heating coil 500.

The pipe 110 may be manufactured in an ongoing or substantially continuous manufacturing or production process. The ongoing manufacturing process may include manufacturing a specified length of pipe without a significant stoppage or break in the manufacturing process. The wrapping of the inner thermoplastic pipe 220 may occur in a substantially continuous fashion. The heating of the pipe 110 by the induction heating coil 500 may also occur in a substantially continuous fashion. For example, the pipe 110 may move at a specified speed longitudinally in the direction 510 to create a continuous production process. The pipe 110 may move continuously for a portion of the manufacturing process. While the pipe 110 is moving, the induction heating coil 500 may heat different portions of the pipe 110. For example, when a portion of the pipe 110 enters the induction heating coil 500, it may begin being heated and when a portion of the pipe 110 exits the induction heating coil 500, it may have been heated enough to allow the layers to fuse.

While the pipe is traveling in direction 510, the wrapping of the outer layer of thermoplastic material 240 may be occurring substantially continuously in the direction of the arrows 520. This may result in the inner thermoplastic pipe 220 being wrapped consistently by the outer layer of thermoplastic material 240. The continuous production process of the pipe 110 may be one or more of more efficient, quicker, or may result in a product that is more consistent or has more desirable properties (e.g. strength and durability) than a batch-manufactured pipe.

In an example, the pipe 110 may be heated using both an induction heater and another heat source. For example, the pipe 110 may be heated using radiant or convention heating as well as induction heating. In an example, the pipe 110 may be preheated using a radiant heater and then passed through the induction heating coil 500 to accomplish the final fusing of the respective layers. In an example, the preheating process may be accomplished by using one or more of a warm manufacturing environment, a preheated inner thermoplastic pipe 220, a preheated outer layer of thermoplastic material 240, or a preheated IHCM 230. In an example, the inner thermoplastic pipe 220 may be extruded in a substantially continuous process along with the manufacturing of the pipe 110, which may provide a degree of heat for the fusing. In an example, the pipe 110 may be cooled at one or more points in the manufacturing process. For example, the pipe may be cooled to solidify one or more seams before additional layers are added or another manufacturing process begins.

The IHCM 230 may be infused or embedded in the inner thermoplastic pipe 220, the outer layer of thermoplastic material 240, or both. In a case where the IHCM 230 is applied as a distinct layer between the inner thermoplastic pipe 220 and the outer layer of thermoplastic material 240, the IHCM 230 may be permeable to allow thermoplastic material to seep through the IHCM 230. For example, one or more of the inner thermoplastic pipe 220 or the outer layer of thermoplastic material 240 may seep through the IHCM 230 to fuse with another layer.

In a case where the IHCM 230 is included in the outer layer of thermoplastic material 240, the IHCM 230 may be infused within the outer layer of thermoplastic material 240. For example, carbon fibers in the form of a strand, mat, or fabric may be infused in a thermoplastic material to form the outer layer of thermoplastic material 240. In an example, the outer layer of thermoplastic material 240 may be formed by impregnating an IHCM 230 with thermoplastic. For example, liquid thermoplastic may be poured over an IHCM and impregnate the IHCM to form the outer layer of thermoplastic material 240. In an example, the IHCM 230 can be a metal powder that is infused, embedded, or impregnated into one or more portions of the pipe 110.

The method of FIG. 4 may include supplying the IHCM 230 in at least one of a specified quantity or a specified form to result in a pipe 110 that is electrically conductive. For example, the IHCM 230 may be supplied in a sufficient quantity to result in a pipe of a desired level of conductivity. In an example, a specified form of IHCM may result in a conductive pipe, such as a fabric or strand that spans a length of pipe.

The present devices and methods are believed to apply to a range of potential applications, which is not limited to spoolable plastic pipe. For example, these devices and methods may apply to non-spoolable pipe that is manufactured and transported in straight sections. For example, these devices and methods may apply to a pipe that is not thermoplastic but whose materials may behave similar to a thermoplastic (i.e. fusing when heated). For example, these devices and methods may apply to a device that is not a pipe, but may be a tank, tube, or other similar device that includes a fused inner portion and outer portion.

### Examples

Example 1 is a pipe comprising: an inner thermoplastic pipe; an outer layer of thermoplastic material wrapped around the inner thermoplastic pipe, wherein the outer layer of thermoplastic material is fused with the inner thermoplastic pipe; and an induction heating compatible material (IHCM) within or between at least one of the inner thermoplastic pipe or the outer layer of thermoplastic material.

In Example 2, the subject matter of Example 1 optionally includes wherein the IHCM is configured to provide heat through induction heating for fusing the inner thermoplastic pipe and the outer layer of thermoplastic material.

In Example 3, the subject matter of any one or more of Examples 1-2 optionally include wherein the outer layer of thermoplastic material includes at least one of a strand, tape, or sheet.

In Example 4, the subject matter of any one or more of Examples 1-3 optionally include wherein the IHCM includes a distinct layer between the inner thermoplastic pipe and the outer layer of thermoplastic material.

In Example 5, the subject matter of Example 4 optionally includes wherein the IHCM is permeable to allow at least one of the inner thermoplastic pipe or the outer layer of thermoplastic material to seep through the IHCM and fuse with at least one of the inner thermoplastic pipe or the outer layer of thermoplastic material.

In Example 6, the subject matter of any one or more of Examples 1-5 optionally include wherein the IHCM is within the outer layer of thermoplastic material.

In Example 7, the subject matter of any one or more of Examples 1-6 optionally include wherein the IHCM includes carbon fiber.

In Example 8, the subject matter of any one or more of Examples 1-7 optionally include wherein the pipe is electrically conductive.

In Example 9, the subject matter of any one or more of Examples 1-8 optionally include wherein the pipe is reinforced with fiberglass.

Example 10 is a method of manufacturing a pipe, the method comprising: wrapping an inner thermoplastic pipe with an outer layer of thermoplastic material, wherein at least one of the inner thermoplastic pipe, the outer layer of thermoplastic material, or a separate layer provides an induction heating compatible material (IHCM); and using an induction heater, heating the IHCM to fuse the inner thermoplastic pipe with the outer layer of thermoplastic material.

In Example 11, the subject matter of Example 10 optionally includes applying a material including an IHCM as a distinct layer between the inner thermoplastic pipe and an outer layer of thermoplastic material.

In Example 12, the subject matter of Example 11 optionally includes applying the IHCM as at least one of a tape, strand, sheet, or distributed particle.

In Example 13, the subject matter of any one or more of Examples 11-12 optionally include wherein the IHCM is permeable to allow at least one of the inner thermoplastic pipe or the outer layer of thermoplastic material to seep through the IHCM and fuse with at least one of the inner thermoplastic pipe or the outer layer of thermoplastic material.

In Example 14, the subject matter of any one or more of Examples 10-13 optionally include wherein the IHCM is infused in the outer layer of thermoplastic material before the wrapping the inner thermoplastic pipe with the outer layer of thermoplastic material.

In Example 15, the subject matter of Example 14 optionally includes wherein the outer layer of thermoplastic material is manufactured by impregnating an IHCM with a thermoplastic material.

In Example 16, the subject matter of any one or more of Examples 10-15 optionally include applying the IHCM to a face of the outer layer of thermoplastic material before the wrapping the inner thermoplastic pipe with the outer layer of thermoplastic material.

In Example 17, the subject matter of any one or more of Examples 10-16 optionally include wherein the wrapping the inner thermoplastic pipe with the outer layer of thermoplastic material includes wrapping the inner thermoplastic pipe with at least one of a strand, tape, or sheet.

In Example 18, the subject matter of any one or more of Examples 10-17 optionally include supplying the IHCM in at least one of a sufficient quantity or specified form such that the pipe is electrically conductive.

In Example 19, the subject matter of any one or more of Examples 10-18 optionally include wherein the IHCM is located at or near a seam between the inner thermoplastic pipe and the outer layer of thermoplastic material.

In Example 20, the subject matter of any one or more of Examples 10-19 optionally include continuously moving the pipe through the induction heater longitudinally to create a continuous production process.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like.

Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A pipe comprising:
an inner thermoplastic pipe;
an outer layer of thermoplastic material wrapped around the inner thermoplastic pipe, wherein the outer layer of thermoplastic material is fused with the inner thermoplastic pipe; and
an induction heating compatible material (IHCM) within or between at least one of the inner thermoplastic pipe or the outer layer of thermoplastic material.

2. The pipe of claim 1, wherein the IHCM is configured to provide heat through induction heating for fusing the inner thermoplastic pipe and the outer layer of thermoplastic material.

3. The pipe of claim 1, wherein the outer layer of thermoplastic material includes at least one of a strand, tape, or sheet.

4. The pipe of claim 1, wherein the IHCM includes a distinct layer between the inner thermoplastic pipe and the outer layer of thermoplastic material.

5. The pipe of claim 4, wherein the IHCM is permeable to allow at least one of the inner thermoplastic pipe or the outer layer of thermoplastic material to seep through the IHCM and fuse with at least one of the inner thermoplastic pipe or the outer layer of thermoplastic material.

6. The pipe of claim 1, wherein the IHCM is within the outer layer of thermoplastic material.

7. The pipe of claim 1, wherein the IHCM includes carbon fiber.

8. The pipe of claim 1, wherein the pipe is electrically conductive.

9. The pipe of claim 1, wherein the pipe is reinforced with fiberglass.

10. A method of manufacturing a pipe, the method comprising:
wrapping an inner thermoplastic pipe with an outer layer of thermoplastic material, wherein at least one of the inner thermoplastic pipe, the outer layer of thermoplastic material, or a separate layer provides an induction heating compatible material (IHCM); and
using an induction heater, heating the IHCM to fuse the inner thermoplastic pipe with the outer layer of thermoplastic material.

11. The method of claim 10, further comprising applying a material including an IHCM as a distinct layer between the inner thermoplastic pipe and an outer layer of thermoplastic material.

12. The method of claim 11, further comprising applying the IHCM as at least one of a tape, strand, sheet, or distributed particle.

13. The method of claim 11, wherein the IHCM is permeable to allow at least one of the inner thermoplastic pipe or the outer layer of thermoplastic material to seep through the IHCM and fuse with at least one of the inner thermoplastic pipe or the outer layer of thermoplastic material.

14. The method of claim 10, wherein the IHCM is infused in the outer layer of thermoplastic material before the wrapping the inner thermoplastic pipe with the outer layer of thermoplastic material.

15. The method of claim 14, wherein the outer layer of thermoplastic material is manufactured by impregnating an IHCM with a thermoplastic material.

16. The method of claim 10, further comprising applying the IHCM to a face of the outer layer of thermoplastic material before the wrapping the inner thermoplastic pipe with the outer layer of thermoplastic material.

17. The method of claim 10, wherein the wrapping the inner thermoplastic pipe with the outer layer of thermoplastic material includes wrapping the inner thermoplastic pipe with at least one of a strand, tape, or sheet.

18. The method of claim 10, further comprising supplying the IHCM in at least one of a sufficient quantity or specified form such that the pipe is electrically conductive.

19. The method of claim 10, wherein the IHCM is located at or near a seam between the inner thermoplastic pipe and the outer layer of thermoplastic material.

20. The method of claim 10, further comprising continuously moving the pipe through the induction heater longitudinally to create a continuous production process.
